(19) United States
(12) Patent Application Publication
(10) Pub. No.: US 2003/0098738 A1
(43) Pub. Date: May 29, 2003

(54) Current generator circuit for high-voltage applications

(75) Inventor: Arthur Descombes, Kerzers (CH)

Correspondence Address: SUGHRUE MION, PLLC, 2100 PENNSYLVANIA AVENUE, N.W., WASHINGTON, DC, 20037, US

(73) Assignee: EM MICROELECTRONIC-MARIN SA

(21) Appl. No.: 10/303,020

(22) Filed: Nov. 25, 2002

(30) Foreign Application Priority Data
Nov. 26, 2001 (CH) 2171/01

(51) Int. Cl. G05F 1/10

(52) U.S. Cl. 327/538

(57) ABSTRACT

There is described a current generator circuit (20) including means (200, 202, 203) for generating a reference current (I_{REF}) and a current mirror (210) connected to a first supply potential (V_{HV}) and including a reference branch (211) which the reference current (I_{REF}) is applied and an output branch (212) delivering, at one output (B) of said current generator circuit, an output current (I_{OUT}) which is the image of said reference current (I_{REF}) and in a determined ratio with respect to said reference current (I_{REF}). The reference current generating means include in particular a MOSFET transistor (202) series connected by its drain and source terminals in said reference branch (211). The current generator circuit (20) further includes limiting means (400) for limiting the potential level of the output (B) of the current generator circuit to an extreme value.

The present invention generally concerns the field of current generator circuits. More particularly, the present invention relates to a current generator circuit powered by a high-voltage power supply (of the order of ten to several tens of volts).

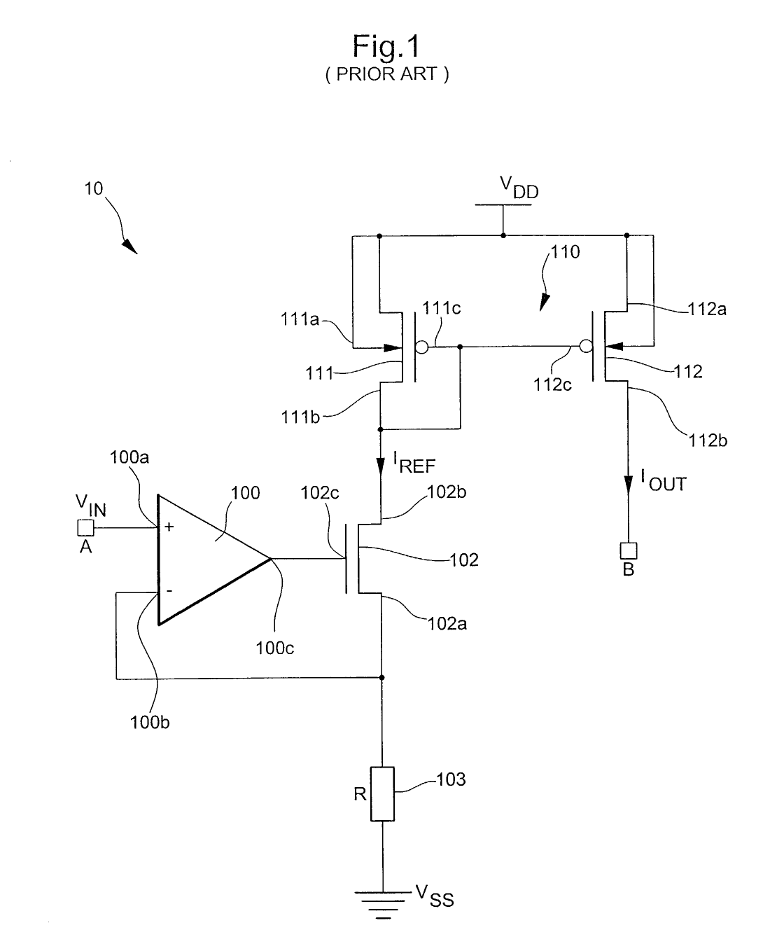

Current generator circuits, commonly known by the name “current sources” or “current sinks” are important elements in the design of numerous electric and electronic circuits. FIG. 1 shows an example of a typical current generator circuit designated as a whole by the reference numeral 10. This current generator circuit 10 constitutes a voltage controlled current generator circuit.

Current generator circuit 10 typically includes amplification means formed of an operational or differential amplifier 100, a transistor 102 and a resistive element 103. Differential amplifier 100 includes a positive input terminal (non inverting input) 100a at which an input voltage designated V_{IN} is applied, a negative input terminal (inverting input) 100b and an output 100c. It will be noted that terminal 100a of differential amplifier 100 forms an input or control terminal A of the current generator circuit. This amplification means 100 supplies a voltage at its output 100c in response to the difference between the voltages applied respectively to its first and second input terminals 100a and 100b.

Transistor 102 is formed in this example of an n-MOS field effect transistor (n-MOSFET) whose gate 102c is connected to output 100c of differential amplifier 100. The source 102a of transistor 102 is connected to negative input 100b of differential amplifier 100 and to a first terminal of resistive element 103. The other terminal of resistive element 103 is connected to a supply potential V_{SS} here forming ground.

According to the generator circuit of FIG. 1, a current designated I_{REF} passes through the drain-source branch 102a-102b of transistor 102. It will be understood that differential amplifier 100 modifies the voltage at its output 100c such that the voltage present at its negative input 100b is substantially equal to the voltage present at its positive input 100a, i.e. substantially equal to input voltage V_{IN}. The voltage at the terminals of resistive element 103 is thus substantially equal to input voltage V_{IN}, such that current I_{REF} passing through the drain-source branch of transistor 102 is given by I_{REF}=V_{IN}/R, where R is the resistance value of resistive element 103. The current I_{REF} generated is thus proportional to the input voltage V_{IN} applied at positive input 100a of the differential amplifier.

The generator circuit of FIG. 1 further includes a current mirror, designated as a whole by the reference 110, including a reference branch connected to source 102b of transistor 102 and at least one output branch delivering an output current I_{OUT} that is the image of current I_{REF} passing through the reference branch. The reference branch of current mirror 110 typically includes a first p-MOSFET transistor 111 whose source 111a is connected to a second supply potential, designated V_{DD}, the gate 111c and drain 111b of this transistor both being connected to drain terminal 102b of transistor 102. The output branch of current mirror 110 includes a second p-MOSFET transistor 112 whose source 112a is connected to potential V_{DD}, the gate 112c of this transistor 112 being connected to the gate 111c of transistor 111 of the reference branch. The drain terminal 112b of transistor 112 forms output terminal B of current generator circuit 10. The current I_{OUT} delivered at this output B is the image of current I_{REF} in the reference branch of the current mirror in a ratio determined by the dimensions of transistors 111 and 112.

One drawback of the solution of FIG. 1 lies in the fact that it is not suited for use in applications using high supply voltages. In particular, for high-voltage applications, transistors 102 and 112 of the voltage generator circuit could be subjected to too high drain-source voltages which would lead to the breakdown of these components. Another drawback of this solution for high supply voltage applications lies in the fact that output terminal B of the generator circuit could be brought to too high voltage levels potentially able to damage the circuits connected to the current generator circuit.

One object of the present invention is thus to propose a current generator circuit which overcomes, in particular, the aforementioned drawbacks. Another object of the present invention is also to propose a solution that is simple and relatively inexpensive to manufacture.

The present invention therefore concerns a current generator circuit whose features are stated in claim 1.

Advantageous embodiments of the present invention form the subject of the dependent claims.

According to the invention, the reference current of the current generator circuit is thus advantageously generated by means of a specific high-voltage MOSFET transistor capable of having at its terminals a drain-source voltage of the order of several tens of volts. Consequently, the constraints imposed on the circuit because of the high supply voltage are better tolerated. The high-voltage MOSFET transistor used is preferably and advantageously an n-channel (or p-channel) MOSFET transistor, including a gate oxide having a greater thickness on the drain side than on the source side and a buffer zone on the drain side formed by an n (or p) type well.

According to the invention, the current generator circuit further advantageously includes an additional circuit allowing the output potential level to be limited (with respect to a reference potential) to a maximum level, in order to prevent causing any damage to the circuits connected to this output, particularly when there is no load connected to the output.

Other features and advantages of the present invention will appear more clearly upon reading the following detailed description, made with reference to the annexed drawings, given by way of non-limiting example and in which:

FIG. 1, already presented, shows a schematic diagram of a typical current generator circuit powered by a low supply voltage;

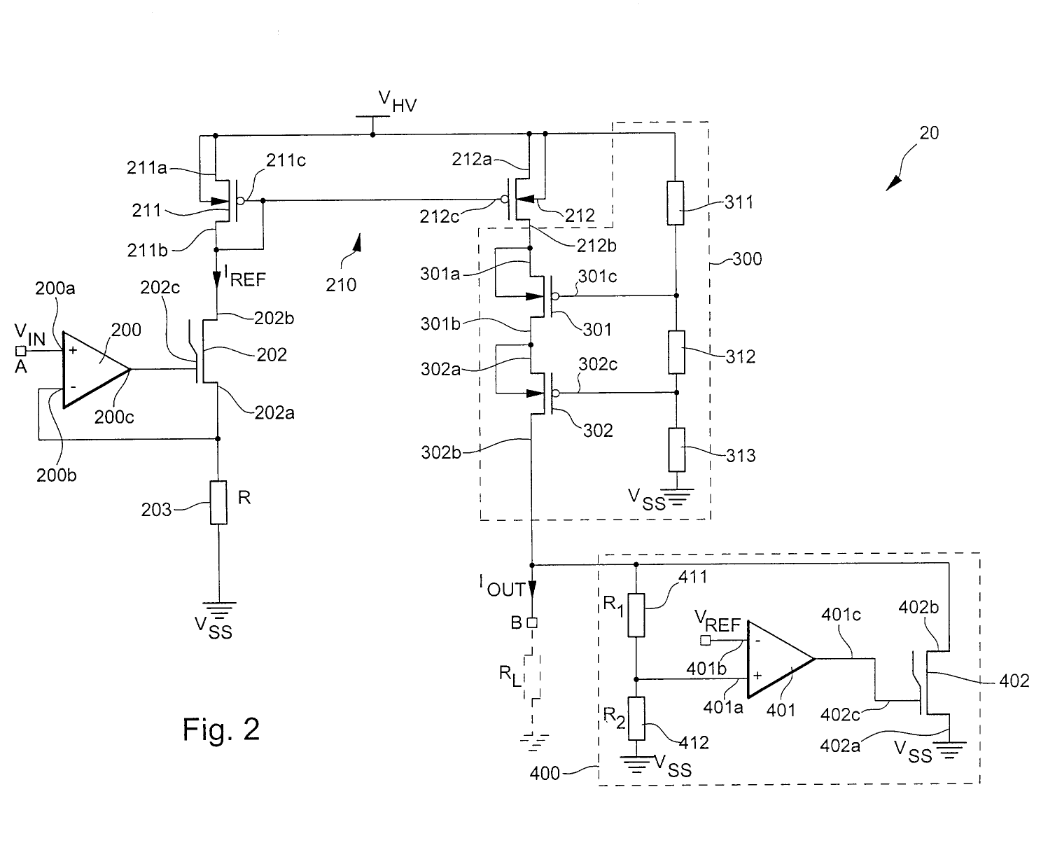

FIG. 2 shows an embodiment of a current generator circuit according to the present invention; and

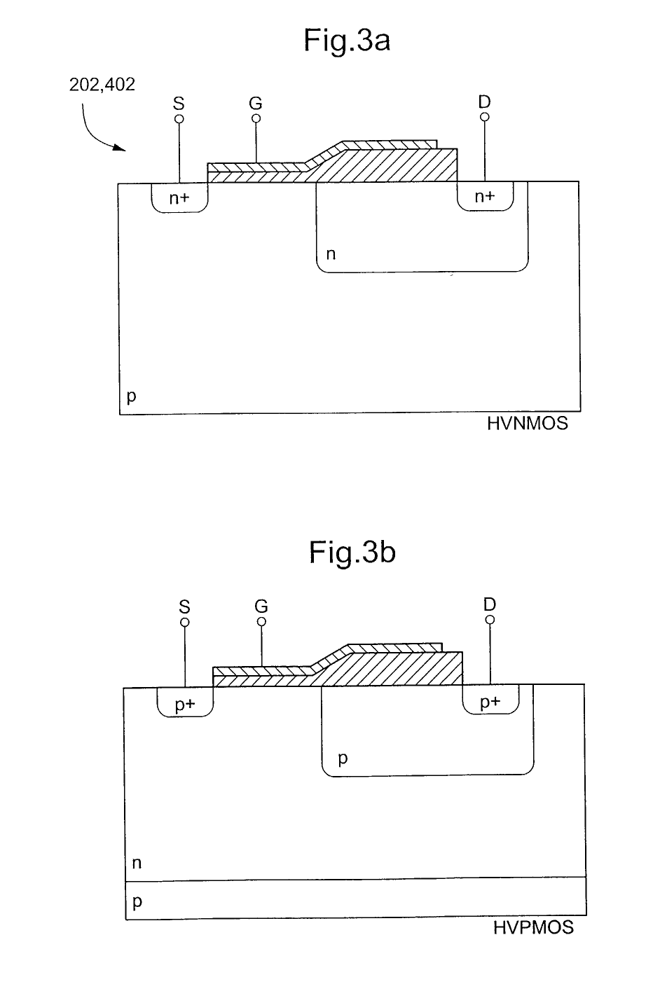

FIGS. 3a and 3b are schematic cross-sections of high-voltage MOSFET, respectively n channel and p channel transistors, made in accordance with standard CMOS technology.

FIG. 2 shows an embodiment of a current generator circuit according to the present invention, designated as a whole by the reference numeral 20. Like the circuit of FIG. 1, current generator circuit 20 includes a differential amplifier 200, a transistor 202, a resistive element 203 and a current mirror 210 including first and second p-MOSFET transistors 211, 212 connected in the same way as elements 100, 102, 103, 111 and 112 of FIG. 1. Unlike the preceding circuit, transistor 202 is a specific high-voltage MOSFET transistor. This high-voltage MOSFET transistor 202, of the n channel type here, is already known to those skilled in the art. The peculiarity of this high-voltage transistor 202 lies in particular in the specific structure of the gate oxide which has a greater thickness on the drain side than on the source side and in the presence of a buffer zone on the drain side formed of an n type well (or p type for a high-voltage p channel MOSFET transistor).

FIGS. 3a and 3b respectively show diagrams of a high-voltage n channel MOSFET transistor, or HVNMOS, and a high-voltage p channel MOSFET transistor or HVPMOS. HVNMOS transistors have the particular advantage of a high breakdown voltage typically greater than 30 volts. Another advantage of this type of transistor lies in the fact that they can be manufactured perfectly compatibly with standard CMOS technology.

For more ample detail concerning this type of high-voltage transistor, reference can be made to the article by Messrs C. Bassin, H. Ballan and M. Declercq entitled “High-Voltage Devices for 0.5 μm Standard CMOS Technology”, IEEE Electron Device Letters, vol. 21, No. 1, January 2000, relating to the manufacture of such high-voltage transistors in 0.5 micron technology. By way of example, it is clear from Table 1 of this document that a high-voltage n channel MOSFET transistor with a breakdown voltage of the order of 30 volts can be made in standard CMOS technology without this requiring any masks or additional implants.

With reference once again to FIG. 2, high-voltage MOSFET transistor 202 is thus connected by its drain terminal 202b to drain terminal 21lb of p-MOS transistor 211 of current mirror 210 and by its source terminal 202 to resistive element 203.

The current generator circuit of FIG. 2 is powered by a high-voltage supply V_{HV}-V_{SS} of the order of ten to several tens of volts. By way of non-limiting example, this supply voltage is of the order of 15 volts. This supply voltage can for example be delivered by means of a high-voltage regulator circuit. Such a high-voltage regulator including an external regulation device is for example disclosed in European Patent Application No. 01202429.5 filed on Jun. 25, 2001, also in the name of the present Applicant.

According to the invention, it will be understood that the use of high-voltage MOSFET transistor 202 in the reference branch of current mirror 210 prevents any breakdown of the components in this reference branch. Moreover, because of the high breakdown voltage of transistor 202 (of the order of 30 volts), the circuit has great flexibility of use as regards supply voltage V_{HV}-V_{SS}.

According to the invention, current generator circuit 20 further includes means, designated as a whole by the reference numeral 400, allowing the potential level of output B of the circuit at which output current I_{OUT} is delivered to be limited to a determined extreme potential, particularly in the case in which the output is not connected to any circuit (open circuit—infinite load resistance R_{L}). In the example illustrated, these means 400 are arranged to limit the potential level of output B to a maximum value, designated V_{OUT,MAX,} fixed purely by way of illustrative example to 10 volts.

Means 400 thus comprise a voltage divider circuit formed in this example of a resistive divider including first and second resistive elements 411 and 412, of value R₁ and R₂, connected between output terminal B and a third reference potential, also chosen to be equal to supply potential V_{SS} forming ground. The connection node between resistive elements 411 and 412 is connected to a positive input terminal (non-inverting terminal) 401a of a second differential amplifier 401, a reference voltage V_{REF} being applied to the negative input terminal (inverting terminal) 401b of differential amplifier 401. It will be noted that reference voltage V_{REF} (in the same way as input voltage V_{IN} of the current generator circuit) can for example be a bandgap type temperature stable voltage reference well known to those skilled in the art (bandgap voltage is a voltage of the order of 1.2 volts).

Output terminal 401c of differential amplifier 401 is connected to the gate 402c of a second high-voltage MOSFET transistor, also of the n type channel, whose drain is connected to output B of current generator circuit 20 and the source is connected to supply potential V_{SS}. Values R₁ and R₂ of resistive elements 411 and 412 are chosen so as to fix the potential level of output B to the extreme value (here maximum) V_{OUT,MAX} designated hereinbefore. Values R₁ and R₂ of resistive elements 411, 412 are also chosen so as to limit the current flowing in this branch. By way of purely illustrative numerical example, the sizing of the components of the current generator circuit can be chosen such that the delivered output current I_{OUT} is of the order of 10 mA. For a reference voltage V_{REF} of the order of 1.2 volts applied at the negative input of differential amplifier 401, resistance values R₁ and R₂ respectively equal to 88 kΩ and 12 kΩ allow the maximum potential level of output B to be fixed at 10 volts, while drawing a maximum current of the order of only 0.1 mA into the branch of the resistive voltage divider circuit.

Means 400 thus assure that the potential level of output B of the current generator circuit does not exceed the value V_{OUT,MAX} defined at 10 volts in this case. As soon as the output potential level exceeds the fixed threshold, the output of the differential amplifier commands the activation of high-voltage MOSFET transistor 402 to counter-balance this increase and keep output B at the defined maximum potential level.

In addition to means 400, current generator circuit 20 further preferably includes protective means 300 to prevent the breakdown particularly of transistor 212 of the output branch of current mirror 210, for example in the event of a short-circuit at ground of output B of the current generator circuit. These protective means 300 can for example include one or more cascode-connected transistors in the output branch of current mirror 210. In this example, for a supply voltage V_{HV}-V_{SS} of the order of 15 volts, two additional transistors 301 and 302 series connected with transistor 212 are sufficient. A resistive divider circuit 311, 312, 313 allow the gate potentials of transistors 301 and 302 to be fixed at suitable levels, for example 10 and 5 volts respectively.

It will be understood that protective means 300 allow the output branch voltage to be distributed and prevent the gate-source, gate-drain and drain-source voltages of the transistors of this branch exceeding a maximum value, in the most adverse case in which a zero load (short-circuit−R_{L}=0) is connected to output B of the generator circuit.

It will also be understood that means 400 prevent the potential of output B being able to rise towards V_{HV} (in the case of an infinite load resistance R_{L}), which would mean, for example, that the gate-drain voltage of transistor 302 could exceed a critical value.

Means 300 and 400 thus act in a complementary manner in order to assure the integrity of the current generator circuit components in accordance with the present invention.

Alternatively, protective means 300 could perfectly well include a third high-voltage MOSFET transistor of the type of transistors 202 and 402 series connected by its drain and source terminals in the output branch of current mirror 210.

It will be understood that various modifications and/or improvements obvious to those skilled in the art can be made to the embodiments described in the present description without departing from the scope of the invention defined by the annexed claims.

By way of improvement, one could for example improve the stability of the output current as a function of temperature by means of the method and device disclosed in European Patent Application No. 00202059.2 of 13.06.2000, entitled “Procédé de génération d'un courant sensiblement indépendent de la température et dispositif permettant de mettre en oeuvre ce procédé”, also in the name of the present Applicant.

What is claimed is:

1. A current generator circuit including means for generating a reference current and a current mirror connected to a first supply potential and including a reference branch in which said reference current is applied and an output branch delivering, at an output of said current generator circuit, an output current which is the image of said reference current and in a determined ratio with respect to said reference current,
said reference current generating means including:
a MOSFET transistor including drain, source and gate terminals, this MOSFET transistor being series-connected by its drain and source terminals in said reference branch;
a resistive element connected between the source terminal of said MOSFET transistor and a second supply potential; and
a differential amplifier including a first input connected to a reference input voltage, a second input connected to said source terminal of the MOSFET transistor, and an output connected to said gate terminal of the MOSFET transistor,
wherein said MOSFET transistor is a high-voltage MOSFET transistor and wherein the current generator circuit further includes limiting means for limiting the potential level of said output of the current generator circuit to an extreme value.

2. The current generator circuit according to claim 1, wherein said limiting means include:
a voltage divider circuit connected between said output of the current generator circuit and a third supply potential, and delivering at one output a divided voltage, proportional, in a determined ratio, to the potential level of said output of the current generator circuit;
a second high-voltage MOSFET transistor including drain, source and gate terminals, said second high-voltage MOSFET transistor being connected by its drain and source terminals between said output of the current generator circuit and said third supply potential; and
a second differential amplifier including a first input connected to a reference voltage, a second input connected to the output of said voltage divider circuit and an output connected to the gate terminal of said second high-voltage MOSFET transistor.

3. The current generator circuit according to claim 2, wherein said voltage divider circuit is a resistive divider circuit.

4. The current generator circuit according to claim 1, wherein said high-voltage MOSFET transistor(s) are n or p channel MOSFET transistors, including a gate oxide having a greater thickness on the drain side than on the source side and a buffer zone on the drain side formed of an n or p type well.

5. The current generator circuit according to claim 1, wherein said output branch of the current mirror further includes one or more cascode connected transistors.

6. The current generator circuit according to claim 2, wherein said reference voltage applied to the first input of the second differential amplifier is derived from a bandgap type temperature stable voltage reference.

7. The current generator circuit according to claim 1, wherein said reference input voltage applied to the first input of the first differential amplifier is derived from a bandgap type temperature stable voltage reference.
